(19) United States
(12) Patent Application Publication
(10) Pub. No.: US 2011/0219026 A1
(43) Pub. Date: Sep. 8, 2011

(54) METHOD AND SYSTEM FOR DISTRIBUTING INFORMATION RELATING TO A PIECE OF MUSIC AND/OR A MOVIE/VIDEO

(76) Inventor: Bo Schonemann, Aars (DK)

(21) Appl. No.: 13/126,835

(22) PCT Filed: Oct. 12, 2009
(86) PCT No.: PCT/EP09/07396

§ 371 Date: Apr. 29, 2011

(30) Foreign Application Priority Data
Nov. 4, 2008 (EP) 08019268.5

(51) Int. Cl. G06F 17/30; G06F 15/16

(52) U.S. Cl. 707/769; 707/E17.014

(57) ABSTRACT

A method and a computer system for distributing information relating to a piece of music and/or a movie/video. The computer system comprises a service provider system holding an information database with information parts relating to pieces of music and/or movies/videos and/or artists and/or music albums, and the service provider system further holds a message database with messages relating to one or more advertising parties. The computer system also comprises at least one user terminal communicating with the service provider system.

### FIELD OF THE INVENTION

The present invention relates to a method and a system for distributing information relating to a piece of music and/or a movie/video, and more particularly to a method and system, wherein information relating to a selected piece of music and/or movie/video is forwarded from a user terminal to a server system holding further music and/or movie/video information data, and wherein additional information relating to the selected piece of music and/or movie/video is forwarded from the server system to the user terminal. The server system also holds messages relating to advertising parties, and selected advertising messages are forwarded to the user terminal together with the additional information.

### BACKGROUND OF THE INVENTION

The Internet is a vast comprehensive medium, which now includes millions of unique users. Because of the ease in which advertisers can distribute advertising messages, the Internet has become a popular advertising distribution vehicle. However, it has become increasingly difficult to convert “eyeballs” on the Internet viewing an advertisement into consumers of the product or service being advertised. Advertisers need to not only take advantage of the vastness of the Internet, they must be able to take advantage of the two-way communications channel to effectively target advertising to the proper demographic audience.

Accordingly, there exists a need for a method and a system to enable advertising parties to reach users based on information relating to the user.

### SUMMARY OF THE INVENTION

According to the present invention there is provided a method for distributing information relating to a piece of music and/or a movie/video in a system comprising a service provider system holding an information database with information parts relating to pieces of music and/or movies/videos and/or artists and/or music albums and further holding a message database with messages relating to one or more advertising parties, said system further comprising at least one user terminal communicating with the service provider system, said method comprising:

a) start playing a selected piece of music and/or movie/video at the user terminal and extracting first information comprising several information parts relating to said selected piece of music and/or movie/video,

b) forwarding said first information from the user terminal to the service provider system,

c) determining if there is a match between all of or part of the first information parts with corresponding information part or parts stored in the information database, and if there is a match, then selecting second information stored in the information database and relating to at least part of the first information, said second information holding information parts not being part of the first information,

d) selecting one or more messages from the message database,

e) forwarding said second information and the selected message(s) from the service provider system to the user terminal.

It is preferred that for all or a first part of the messages stored in the message database there is defined one or more criteria whereby each of said messages is associated with a selected number of the information parts stored in the information database. Preferably, in step d) the message(s) is/are selected from messages being associated with the matching information part or parts stored in the information database. It is also within an embodiment of the invention that for a second part of the messages stored in the message database, there are no defined criteria to be met and each of said messages may be associated with any information parts stored in the information database.

If there is no match in step c), then it is preferred to skip step e) and forward the first information and the selected message(s) from the information server to the user terminal.

The method of the invention may further comprise that information being representative to the first and/or second information and the selected message(s) are displayed at the user terminal.

It is within an embodiment of the invention that the matching step c) comprises an identification of the played, selected piece of music and/or movie/video from information parts stored in the information database having a match with said first information part(s).

According to an embodiment of the invention, the matching step c) may comprise:
determining if there is a match between all of or part of the first information parts with information parts stored in the information database, and if not,
altering the information of one or more parts of the first information parts, and
determining if there is a match between the combination of any remaining unaltered first information parts and the altered part(s) with information parts stored in the information database.

It is also within an embodiment of the method of the invention that the matching step c) comprises:

aa) determining if there is a match between all of the first information parts with information parts stored in the information database, and if not,
altering the information of one or more parts of the first information parts, and

bb) determining if there is a match between the combination of any remaining unaltered first information parts and the altered part(s) with information parts stored in the information database. If there is no match in step bb) then the matching step c) may further comprise:

cc) cancelling a first selected part of the unaltered first information parts,

dd) determining if there is a match between all the remaining unaltered first information parts with information parts stored in the information database, and if not,
altering the information of a one or more parts of the remaining unaltered first information parts, and

ee) determining if there is a match between the combination of any remaining unaltered first information part(s) and the altered part(s) with information parts stored in the information database. If there is no match in step dd) then the matching step c) may further comprise:

ff) cancelling a second selected part of the unaltered first information parts;

gg) determining if there is a match between all the remaining unaltered first information parts with information parts stored in the information database, and if not,
altering the information of one or more parts of the remaining unaltered first information parts, and

hh) determining if there is a match between the combination of any remaining unaltered first information part(s) and the altered part(s) with information parts stored in the information database. If there is not match in step hh) then the matching step c) may further comprise:

ii) determining if there is a match between the unaltered first selected part of the first information parts with an information part stored in the information database, and if not,

jj) determining if there is a match between an altered version of the first selected part of the first information parts with a information part stored in the information database.

It is preferred that the advertising parties being represented in the message database has an account at the service provider system.

The method of the invention also comprises one or more embodiments, wherein for at least part of or for all messages there is defined a maximum number of allowable selections within a given time period. Here, a selected message may represent an associated message having the lowest ratio between number of times the message has been selected within the given time period and the maximum number of allowable selections within said given time period.

According to an embodiment of the invention the information database can be updated with news relating to pieces of music, movies/videos, artists and/or music albums by third parties being communicating with the service provider system. The information database may comprise information parts representing pictures and/or album cover pictures.

It is preferred that a selected message comprises one or more advertisements and/or a link to a website of the related advertising party.

According to one or more embodiments of the invention, the service provider system may store one or more music numbers and/or movies/videos, which can be downloaded from the service provider system to a user terminal. Here, at least part of the music numbers and/or movies/videos may be uploaded by third parties to the service provider system. According to a preferred embodiment, at least part of the music numbers and/or movies/videos stored at the service provider system are encrypted, and a service provider media player for playing said encrypted music numbers and/or movies/videos can be downloaded from the service provider system to a user terminal. The service provider media player may be downloaded to a user terminal, and an encrypted music number and/or movie/video may be downloaded from the service provider system and played by use of said service provider media player at the user terminal. When there has been a match in step c) and the played selected piece of music and/or movie/video has been identified and the second information has been forwarded to the user terminal step e), the method of the invention may further comprise that the user provides instructions to the service provider system for forwarding the selected piece of music and/or movie/video and/or information to one more identified receiver. If the selected piece of music and/or movie/video is not available for download from the service provider system, the service provider system may forward information related to the selected piece of music and/or movie/video to the one or more identified receivers. If the selected piece of music and/or movie/video is available as a free download from the service provider system, the service provider system may forward download instructions for the selected piece of music and/or movie/video to the one or more identified receivers. If the selected piece of music and/or movie/video is available as a download, but not as a free download, from the service provider system, the service provider system may forward payment instructions for the selected piece of music and/or movie/video to the one or more identified receivers.

The present invention also comprises an embodiment, wherein the service provider system further holds one or more databases for statistic information, and wherein at least part of the second information and information of the selected messages is stored in the one or more databases for statistic information. It is also within an embodiment of the invention that the user clicks on an advertisement being forwarded to the user terminal as part of a forwarded selected message, and that the clicking on the advertisement is registered at the service provider system and stored in the one or more databases for statistic information.

According to the present invention there is also provided a computer system for distributing information relating to a piece of music and or a movie/video, said computer system comprising:
a service provider system holding an information database with information parts relating to pieces of music and/or movies/videos and/or artists and/or music albums and further holding a message database with messages relating to one or more advertising parties; and
a user terminal communicating with the service provider system;
wherein the user terminal is adapted for playing a selected piece of music and/or movie/video, extracting first information comprising several information parts relating to said selected piece of music and/or movie/video, and forwarding said first information from the service provider system; and
wherein the service provider system is adapted for
determining if there is a match between all of or part of the first information parts with corresponding information part or parts stored in the information database, and when there is a match, selecting second information stored in the information database and relating to at least part of the first information, said second information holding information parts not being part of the first information; said service provider system further being adapted for selecting one or more messages from the message database, and for forwarding said second information and the selected message(s) to the user terminal.

For the system of the invention it is preferred that for all or a first part of the messages stored in the message database there is defined one or more criteria whereby each of said messages is associated with a selected number of the information parts stored in the information database. The service provider system may be adapted for selecting said one or more messages from messages being associated with the matching information part or parts stored in the information database.

The computer system of the invention also comprises an embodiment, wherein for at least part of or for all messages there is defined a maximum number of allowable selections within a given time period. Here, the service provider system may be adapted for selecting a message having the lowest ratio between number of times the message has been selected within the given time period and the maximum number of allowable selections within said given time period.

It is also within an embodiment of the computer system of the invention that for a second part of the messages stored in the message database there are no defined criteria to be met and that each of said second part messages may be associated with any information parts stored in the information database.

The system of the invention also comprises one or more embodiments wherein the service provider system is adapted for forwarding the first information and the selected message(s) to the user terminal, when there is no match between the first information parts and the information parts stored in the information database.

It is preferred that the user terminal is adapted for displaying the first and/or second information and the selected message(s) being received from the service provider system.

It is also preferred that the service provider system is adapted for performing an identification of the played, selected piece of music and/or movie/video from information parts stored in the information database having a match with said first information part(s).

For the system of the invention, the service provider system may be adapted for:
determining if there is a match between all of or part of the first information parts with information parts stored in the information database, and if not,
altering the information of one or more parts of the first information parts, and
determining if there is a match between the combination of any remaining unaltered first information parts and the altered part(s) with information parts stored in the information database.

It is also within embodiments of the system of the invention that the service provider system is adapted for:

aa) determining if there is a match between all of the first information parts with information parts stored in the information database, and if not,
altering the information of one or more parts of the first information parts, and

bb) determining if there is a match between the combination of any remaining unaltered first information parts and the altered part(s) with information parts stored in the information database. If there is no match in bb), then the service provider system may further be adapted for:

cc) cancelling a first selected part of the unaltered first information parts,

dd) determining if there is a match between all the remaining unaltered first information parts with information parts stored in the information database, and if not,
altering the information of one or more parts of the remaining unaltered first information parts, and

ee) determining if there is a match between the combination of any remaining unaltered first information part(s) and the altered part(s) with information parts stored in the information database. If there is no match in ee), then the service provider system may further be adapted for:

ff) cancelling a second selected part of the unaltered first information parts,

gg) determining if there is a match between all the remaining unaltered first information parts with information parts stored in the information database, and if not,
altering the information of one or more parts of the remaining unaltered first information parts, and

hh) determining if there is a match between the combination of any remaining unaltered first information part(s) and the altered part(s) with information parts stored in the information database. If there is not match in hh) then the service provider system may further be adapted for:

ii) determining if there is a match between the unaltered first selected part of the first information parts with a information part stored in the information database, and if not,

jj) determining if there is a match between an altered version of the first selected part of the first information parts with an information part stored in the information database.

Also for the system of the invention, the information database may comprise information parts representing pictures and/or album cover pictures. It is also within an embodiment of the system of the invention that a selected message comprises one or more advertisements and/or a link to a website of the related advertising party.

It is within an embodiment of the system of the invention that the service provider system stores one or more music numbers and/or movies/videos, which can be downloaded from the service provider system to a user terminal. Here, at least part of the music numbers and/or movies/videos stored at the service provider system may be encrypted, and a service provider media player for playing said encrypted music numbers and/or movies/videos may be provided for downloading from the service provider system to a user terminal.

It is furthermore within an embodiment of the invention that the service provider system further holds one or more databases for statistic information, and that at least part of the second information and information of the selected messages is stored in the one or more databases for statistic information.

The invention will be further described in the following with the aid of the accompanying drawings.

### BRIEF DESCRIPTION OF THE DRAWINGS

FIG. 1 is a block diagram illustrating an example of upload of music related information from a third party to the server of a service provider,

FIG. 2 is a block diagram illustrating distribution of music related information and advertising messages according to an embodiment of the invention,

FIG. 3 is a flow diagram illustrating a procedure of determining a match between information received from a user and information stored at the service provider system according to an embodiment of the invention,

FIG. 4 is a block diagram illustrating examples of how a user can obtain pieces of music to be played on the users terminal or computer,

FIG. 5 is a block diagram illustrating how a user can forward music related information to a receiving party according to an embodiment of the invention,

FIG. 6 is a block diagram illustrating collection of statistic data relating to distributed information and messages according to an embodiment of the invention,

FIG. 7 is a block diagram illustrating communication flow when a user activates a received advertising message according to an embodiment of the invention,

FIG. 8 is a block diagram illustrating the creation of an advertising message being associated with stored music related information parts according to an embodiment of the invention, and

FIG. 9 is a flow diagram illustrating the selection of an advertising message according to an embodiment of the invention.

### DETAILED DESCRIPTION OF THE INVENTION

### Upload of Music Information

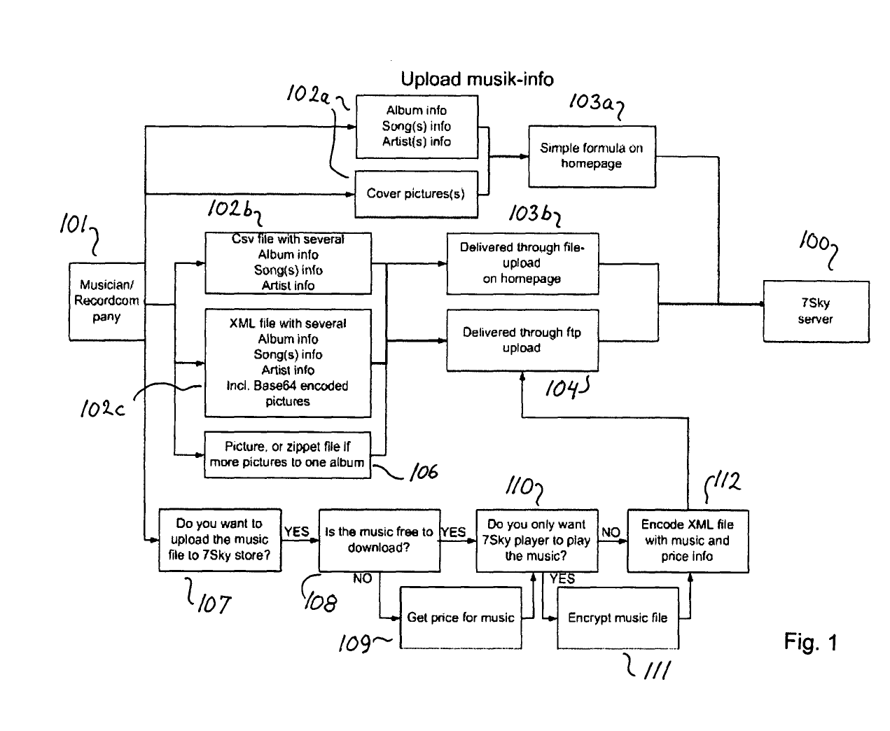

FIG. 1 is a block diagram illustrating an example of upload of music related information from a third party to the server of a service provider according to an embodiment of the invention. Here and in the following the server of the service provider is named “7Sky server”, 100.

Most music related information will be delivered by record companies 101. They may at certain times (eg. once a month) upload new or updated lists, 102a, 102b, 102c, with music related information. The information may include information on one or more albums, and for each album, information on one or more songs and one or more artists. The service provider may accept a csv type file, 102b, where each line contains one title, or one xml file, 102c, containing the same amount.

The upload can be done through the service provider's website, 103b, or by an ftp upload, 104, for more automated processing.

When uploading cover image(s), this can be inserted directly into the xml file, or can be uploaded separately, 106, and in this case, the picture file name should start with the album id. If the pictures are uploaded separately, 106, and there are more covers to one album, they may be packed in a zip file.

If the uploading party has small changes, or is an artist with few albums—they can make changes and add new albums/songs directly on the service provider's website, 102a, 103a.

The various methods of uploading can be mixed.

It is also possible to make the music number available on a store managed by the service provider, 7Sky store, 107. For each number, the uploading party can decide if it's free of charge, 108, or what the number should cost, 109. The music file may also be encrypted, 111, so it can only be played by a corresponding player provided by the service provider, 7Sky player, 110. The encryption of music files may be combined with free song/music numbers to ensure some income from the song/music. The song/music file and price info may be encoded in xml format, 112, and uploaded through ftp, 104.

### Download of Music Information And Advertising Messages

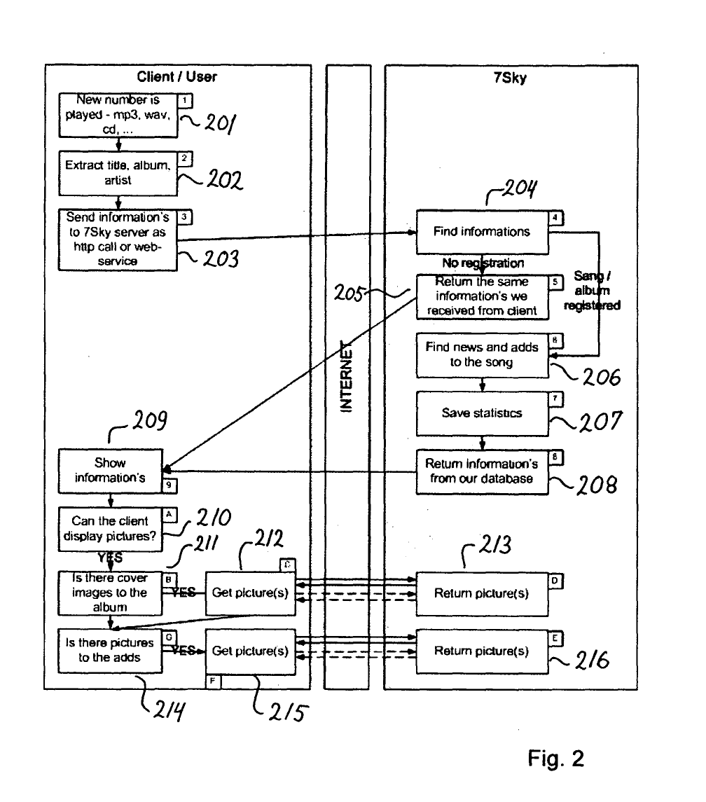

FIG. 2 is a block diagram illustrating distribution of music related information and advertising messages according to an embodiment of the invention.

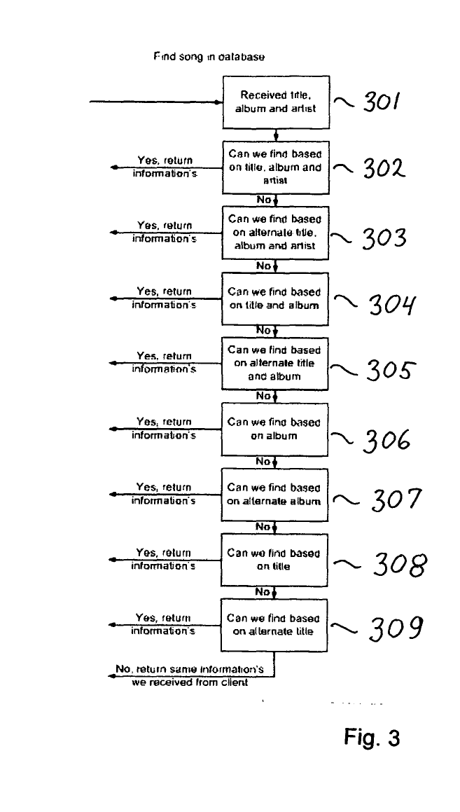

A player can be any user or client terminal, which is programmed or designed to play music, and which has got an Internet connection. Examples may be media players, plug-ins to existing media players, media-centers, mobile phones, etc. When a song is played, 201, the player extracts information's like title, album and artist, 202. For a CD this information may be limited to track-number and a CD id (in the present service provider system, 7Sky system, the CD id is album, and track-number is title). The player or user terminal will call the service provider's website or web-service, 203, with this information. Based on matching rules, which is discussed in connection with FIG. 3, the service provider system will try to find information parts corresponding to or matching the played song or number from information parts stored in a information database at the service provider system, 204.

If there is not found any match between the first information parts received from the player/user terminal and the information parts stored at the information database, the received information on album, title and artist is returned to the player/user terminal, 205, along with some generic advertisements or advertising messages.

If there is found a match between the first information parts received from the player/user terminal and the information parts stored at the information database, then the service provider system selects from the information database a number of second information parts relating to the played song or number, which second information parts include further information, such as news about the performing artist. Furthermore, the service provider system selects one or more advertising messages, 206. The selected second information parts and selected messages are stored in a database for statistical purpose, 207, and then forwarded to the player/user terminal, 208.

The received information is displayed at the player/user terminal, 209. If the forwarded information and messages relate to cover images and/or advertising images, then links to these images is part of the forwarded information messages. If the player/user terminal or client is able to display pictures or images, 210, and if a cover image link is included in the received information, 211, then the user can decide, if he wants to download the cover images from the service provider system, 212, 213. In the same way, if an advertising image link is included in the received messages, 214, then the user can decide, if he wants to download the advertising image(s) from the service provider system, 215, 216. It is also within an embodiment of the invention that cover and/or advertising images are downloaded to the player/user terminal in step 208.

### Find Played Song Or Music Number In Information Database

FIG. 3 is a flow diagram illustrating a procedure of determining a match between information received from a user and information stored at the service provider system according to an embodiment of the invention.

First information including names of album, title and artist, is received at the service provider system from the player/user terminal, 301. The first try is to lookup and match this specific combination with data stored in the information database, 302. If yes, go to step 206 in FIG. 2.

If no match, then try a new match based on alternate names of album, title, and/or artist, 303. Alternate names may be alternate spellings (Electric Light Orchestra=ELO), and also variations in spelling (D.A.D.=DAD=D. A. D.) It yes, go to step 206 in FIG. 2.

If no match, then try a new match based on names of album and title, 304. If yes, go to step 206 in FIG. 2.

If no match, then try a new match based on alternate names of album and/or title, 305. If yes, go to step 206 in FIG. 2.

If no match, then try a new match based on name of album, 306. If yes, go to step 206 in FIG. 2.

If no match, then try a new match based on alternate name of album, 307. If yes, go to step 206 in FIG. 2.

If no match, then try a new match based on name of title, 308. If yes, go to step 206 in FIG. 2.

If no match, then try a new match based on alternate name of title, 307. If yes, go to step 206 in FIG. 2. If no match, then go to step 205 in FIG. 2 and return received information.

If a match is obtained, then missing information parts may be obtained from the information database, news for the artist is looked up in the information database, and advertisement messages related to the played song or music number is selected from the message database, see step 206 in FIG. 2. Information and messages are forwarded to the player/user terminal in an xml encoded format.

### Obtaining Songs Or Music Numbers

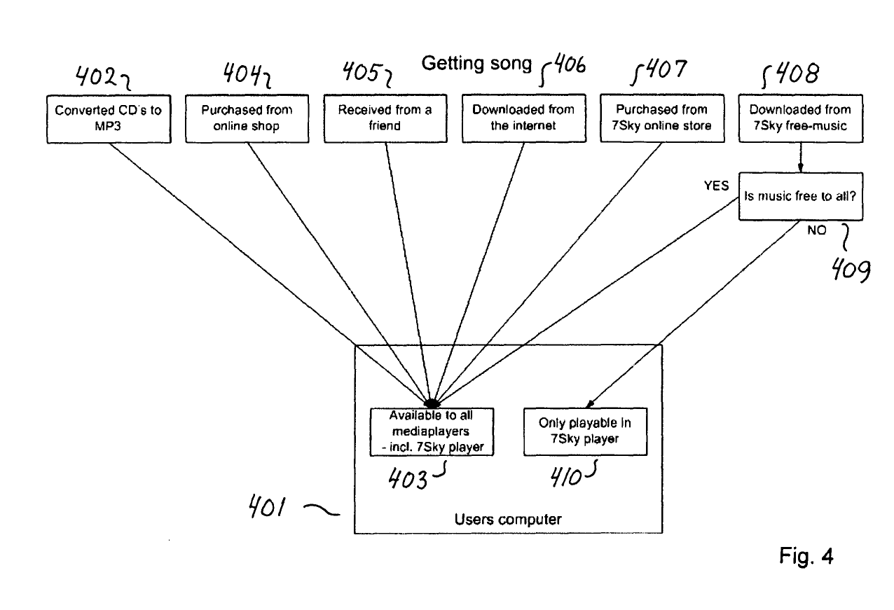

FIG. 4 is a block diagram illustrating examples of how a user can obtain pieces of music to be played on the users terminal or computer, 401.

The user can obtain a music number, such as an mp3 coded music number, from various places. If he converts his CD's into the mp3 format, 402, they will be encoded with CD id and track-number as minimum. The user can get music numbers from many places, and they should be available to all media-players, including the player provided by the service provider, 7Sky player, as well as other players, 403.

The user can get the music numbers from places such as: purchase a number from an online shop, 404, receive a number from a friend, 405, download a number from the Internet, 406, purchase a number from an online store hosted by the service provider, 407, download a number for free from the service provider, 408. The music number from the service provider, 408, may be free to all or the record-company or musician may encrypt the song or number, 409, whereby only the service provider player, 7Sky player, can play the song, 410. The encrypted song may get a new extension—7mp3, to indicate it's a special file type. This way musicians and record-companies can send the encrypted file to people, ensuring they will only be played with the player of the service provider.

### Send Music Number Or Information To A Friend

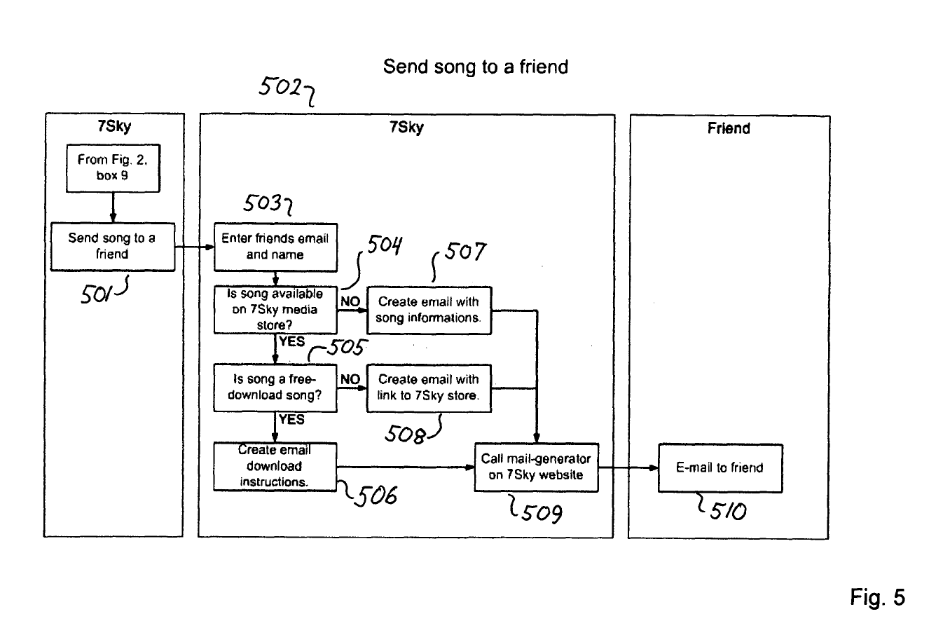

FIG. 5 is a block diagram illustrating how a user can forward music related information to a receiving party, such as a friend, according to an embodiment of the invention.

The information forwarded to a user and displayed at the user terminal, steps 208, 209 in FIG. 2, may comprise a link to a website at the service provider system, 7Sky server, which website is designed for forwarding music related information to a receiver named by the user. This website can be activated from the user terminal, for example by clicking on a “Send song to a friend” icon, 501. When the user clicks on the “Send song to a friend” icon, the user is directed to the website on 7Sky server, 502, which holds the song or music number id, and song or music number info. If the song or music number is not available for download from the service provider system, 7Sky store, basic music information will be displayed at the website. If the song or music number is available for download, but cost money, a link and a price is displayed at the website. If the song or music number is available and free, a link is displayed at the website with a notice this it is a free download. If the user wants to forward the music number or music information to a receiver/friend, then the user/sender enters the name and e-mail address of the receiver/friend at the website, 503, and the user may also write a short message not containing HTML code to avoid spam. The user/sender must also enter a code shown on the website to avoid mass-sending.

When the user has entered the name and email address of the receiver, 503, then the service provider system determines if the music number is available for download, 504. If not, then an email with song or music number information is generated, 507, and this email is forwarded from the service provider system, 509, to the receiver/friend, 510. If the music number is available for download, then the service provider system determines if it is a free download, 505, and if it is not free, then an email with a link to the store at the service provider system, from which it can be bought, is generated, 508, and forwarded from the service provider system, 509, to the receiver/friend, 510. If it is a free download, then an email with download instructions is generated, 506, and forwarded from the service provider system, 509, to the receiver/friend, 510.

### Generation of Statistics

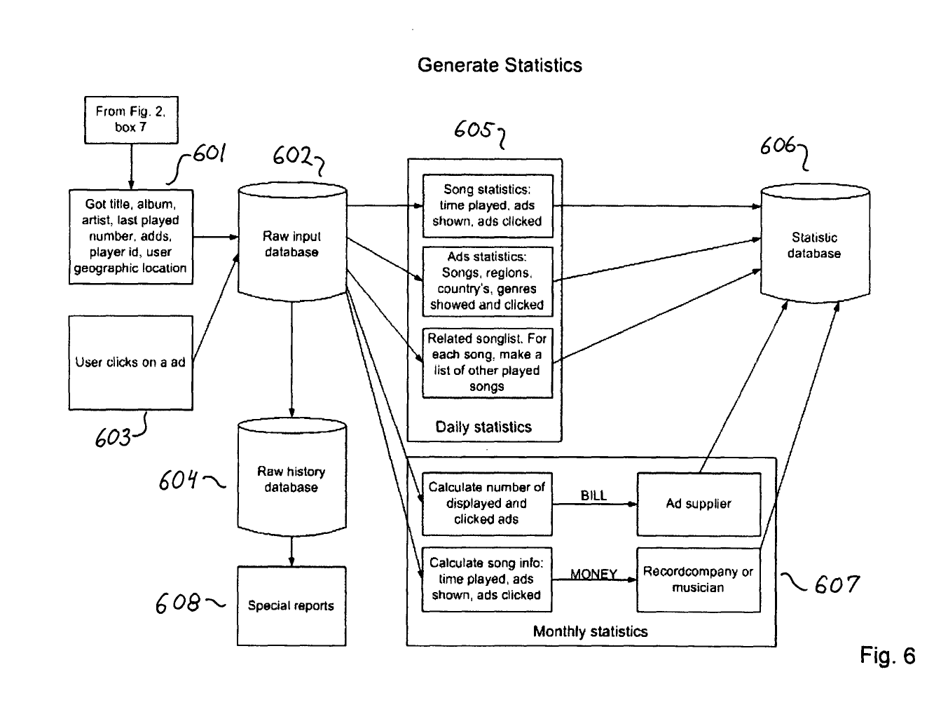

FIG. 6 is a block diagram illustrating collection of statistic data relating to distributed information and messages according to an embodiment of the invention.

Raw statistics is gathered whenever a user plays a number, or the user clicks on an ad. From step 207 in FIG. 2, information parts and advertising messages, which are forwarded from the service provider system to the user, are stored as raw input in a “raw input database”, 601, 602. The information stored in the raw input database, 602, may comprise information going beyond the information forwarded to the user, and may comprise information such as title of song or music number, name of album and artist, previous played song or number, forwarded advertising messages, id or type of the player on which the number is played, and geographic location of user when playing the number.

When the user clicks on an advertisement, 603, being forwarded as part of a forwarded selected message, he is directed to a website of the service provider, the 7Sky website, statistics are saved, 602, and he is forwarded to a homepage of the advertising party being related to the advertisement.

Because raw data is saved, 602, different kind of needed statistics may be generated. Daily statistics, 605, retrieves all records from the raw database, 602, for a certain date, and then the needed statistics may be calculated and stored in a “statistic database”, 606. The daily statistics 605 may include “Song statistics”, which may comprise time of played song/number, how many times a song/number has been played, how many times an advertisement or advertisement message has been displayed, and/or how many times an advertisement has been clicked by a user.

The daily statistics, 605, may also include “Advertising statistics”, which may be useful for advertising parties, and which may comprise information on how many times an advertisement or advertisement message has been displayed and/or how many times and advertisement has been clicked by a user for different songs/numbers, for different regions of songs, for different country's of songs, for different genres of songs, for different regions of users, and/or for different country's of users.

The daily statistics, 605, may further include a “Related song list”, where for each song/number or at least some songs/numbers there is generated a list of other played songs/numbers, which may be related to this song/number.

At regular time intervals, such as once a month, statistics may be generated, 607, for record companies uploading information and/or music numbers to the service provider system, and for the advertising companies or parties, who provide advertisements. This may be used for billing the advertising companies and for sending money to the record companies and thereby the artists or musicians. The record companies may get a list for each artist/musician to use internally. The statistics for an advertising company may include the number of displayed and clicked advertisements related to the advertising company, and the statistics for a record company may for a song/number include the number of times the song/number has been played, the advertisements forwarded and shown or displayed as a result of the song/number being played, and which of the forwarded advertisements, which have been clicked.

After generation of the daily statistics, 605, data stored in the raw input database 602 are moved to a “raw history database” 604, from which special reports or unique statistics, 608, may be generated, for example “What music has been played by a Houston musician singing in a non-English language”.

### Click on An Advertisement

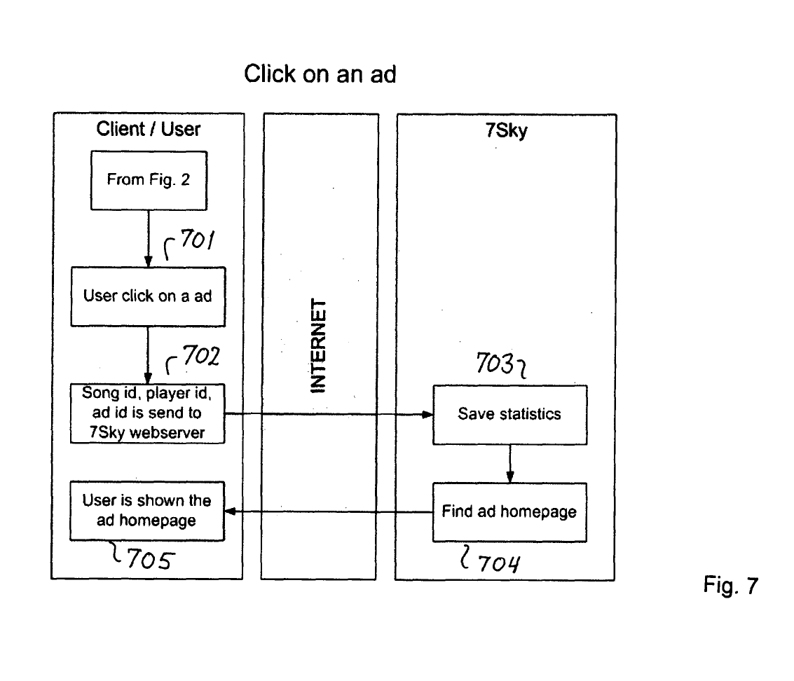

FIG. 7 is a block diagram illustrating communication flow when a user activates a received advertising message according to an embodiment of the invention.

When the user clicks on an advertisement, 701, being forwarded as part of a forwarded selected message, the advertisement id, the music player id, and the id of the played song/number are found, and the user is directed to a website of the service provider, the 7Sky website, statistics are saved, 703, the advertisers homepage is found, 704, and the user web-browser is redirected to the advertisers homepage 705.

### Creation of Advertisements

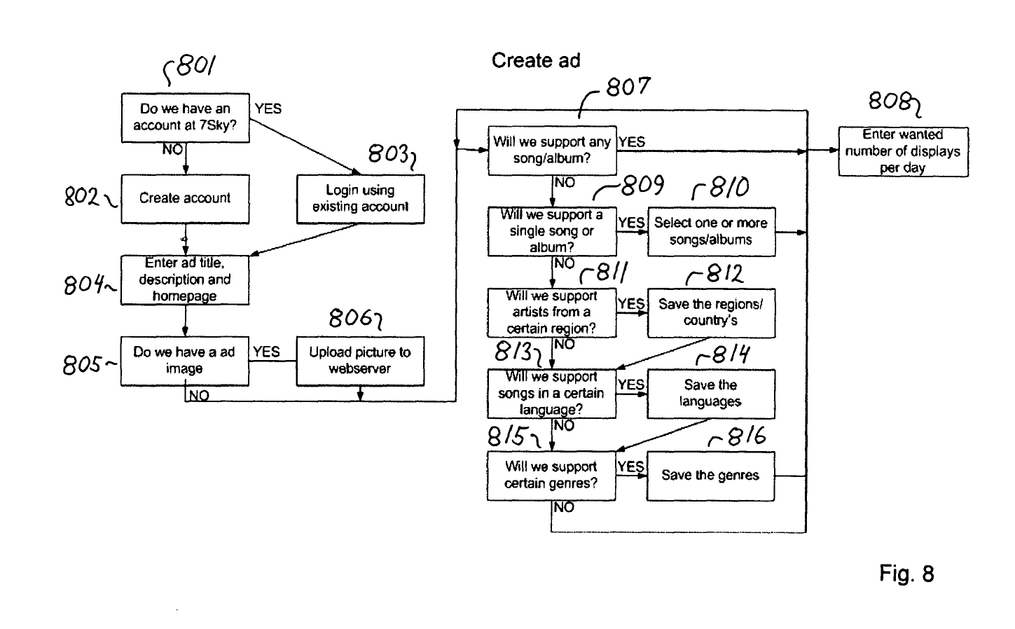

FIG. 8 is a block diagram illustrating the creation of an advertising message being associated with stored music related information parts according to an embodiment of the invention.

An advertising company or party who wants to advertise via the service provided by the service provider, 7Sky, creates an account on the website of the service provider, 801, 802, or logs into an existing account, 803. Then they create one or more advertisements, with a title, a small description and a link to their homepage, 804. They can choose to add an image to the advertisement, 805, and upload this to the server hosting the web- or homepage, 806.

An advertising company can decide that the advertisement may be associated with any song/number, 807, and then enter the wanted maximum number of displays per day, 808. The advertising company may also decide to support a single song/number or album, 809, 810, and then enter the wanted number of displays per day, 808.

The advertising company may decide to associate an advertisement with artists from a certain geographic region, and then save the countries of the region, 811, 812. The company may also have the advertisement associated with songs/numbers in a certain language, and then save the language or languages, 813, 814. The company may also have the advertisement associated with song/numbers of certain genres, and then save the genre or genres, 815, 816.

A very specific filter to associate an advertisement with songs/number could be: “Artists from Houston, playing Heavy Metal in Spanish”.

Finally the advertising customer decides on an advertising budget, defined by the maximum number of displays per day, 808. Various albums/songs can have a higher price per display than others.

### Selecting Advertising Messages

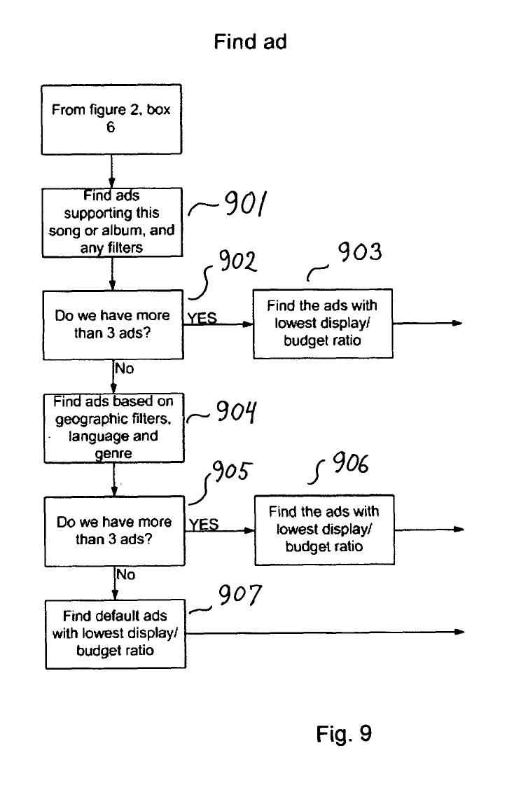

FIG. 9 is a flow diagram illustrating the selection of an advertising message according to an embodiment of the invention.

When a player or user terminal is playing a song/number and requesting song-information, step 204 in FIG. 2, and the song/number is in the information database, the service provider will first see how many advertisements are associated directly with the song/number or the album, 206, 901, and for which advertisements the advertising budget is not used up. It is noted that advertisements directly supporting or being associated with a song/number or album can still use filters so only users from for example a certain country can see the advertisement.

If there are more than three advertisements, for which the budget is not used up, 902, then find the advertisements with the lowest display/budget ratio, 903. The display/budget ratio is calculated based on how many display's the advertising customer wants per day, divided by the current number of times it has been displayed today.

If there is less than three advertisements, for which the budget is not used up, then try to find the remaining advertisements (up to three) using the filters entered with the advertisements, 904. This may be regions, language and genre. Only advertisements that have not used their budget can be selected. If there are more than three advertisements, for which the budget is not used up, 905, then find the advertisements with the lowest display/budget ratio, 906. If there still are less than three selected advertisements, then find advertisements from the generic advertisements, which may be associated with any song/number or album, and select advertisements with the lowest displayed/budget ratio equal to (number of times an advertisement has been displayed on a day)/(maximum defined number of displays per day), 907.

The above-described examples discussed in connection with FIGS. 1-9 deal with music information and song or music numbers, but could also be practiced when dealing with movies/videos and/or movie/video information.

The present invention has been described herein in connection with preferred embodiments thereof. It will be appreciated that provided the detailed disclosure herein, those skilled in the art may envision how the present invention could be practiced using alternative embodiments and variations thereof, including movies/videos and/or movie/video information. Such variations are intended to be within the scope of the present invention, which is defined by the claims appended hereto.

1.-47. (canceled)

48. A method for distributing information relating to a piece of music and/or a movie/video in a system comprising a service provider system holding an information database with information parts relating to pieces of music and/or movies/videos and/or artists and/or music albums and further holding a message database with messages relating to one or more advertising parties, said system further comprising at least one user terminal communicating with the service provider system, said method comprising:
a) start playing a selected piece of music and/or movie/video at the user terminal and extracting first information comprising several information parts relating to said selected piece of music and/or movie/video,
b) forwarding said first information from the user terminal to the service provider system,
c) determining if there is a match between all of or part of the first information parts with corresponding information part or parts stored in the information database, and if there is a match, then selecting second information stored in the information database and relating to at least part of the first information, said second information holding information parts not being part of the first information,
d) selecting one or more messages from the message database,
e) forwarding said second information and the selected message(s) from the service provider system to the user terminal.

49. A method according to claim 48, wherein for all or a first part of the messages stored in the message database there is defined one or more criteria whereby each of said messages is associated with a selected number of the information parts stored in the information database.

50. A method according to claim 49, wherein in step d) the message(s) is/are selected from messages being associated with the matching information part or parts stored in the information database.

51. A method according to claim 50, wherein, if there is no match in step c), then skipping step e) and forwarding the first information and the selected message(s) from the information server to the user terminal.

52. A method according to claim 48, wherein information being representative to the first and/or second information and the selected message(s) are displayed at the user terminal.

53. A method according to claim 48, wherein the matching step c) comprises an identification of the played, selected piece of music and/or movie/video from information parts stored in the information database having a match with said first information part(s).

54. A method according to claim 48, wherein the matching step c) comprises:
determining if there is a match between all of or part of the first information parts with information parts stored in the information database, and if not,
altering the information of one or more parts of the first information parts, and
determining if there is a match between the combination of any remaining unaltered first information parts and the altered part(s) with information parts stored in the information database.

55. A method according to claim 48, wherein the matching step c) comprises:
aa) determining if there is a match between all of the first information parts with information parts stored in the information database, and if not,
altering the information of one or more parts of the first information parts, and
bb) determining if there is a match between the combination of any remaining unaltered first information parts and the altered part(s) with information parts stored in the information database.

56. A method according to claim 55, wherein if there is no match in step bb) then the matching step c) further comprises:
cc) cancelling a first selected part of the unaltered first information parts,
dd) determining if there is a match between all the remaining unaltered first information parts with information parts stored in the information database, and if not,
altering the information of a one or more parts of the remaining unaltered first information parts, and
ee) determining if there is a match between the combination of any remaining unaltered first information part(s) and the altered part(s) with information parts stored in the information database.

57. A method according to claim 56, wherein if there is no match in step dd) then the matching step c) further comprises:
ff) cancelling a second selected part of the unaltered first information parts;
gg) determining if there is a match between all the remaining unaltered first information parts with information parts stored in the information database, and if not,
altering the information of one or more parts of the remaining unaltered first information parts, and
hh) determining if there is a match between the combination of any remaining unaltered first information part(s) and the altered part(s) with information parts stored in the information database.

58. A method according to claim 57, wherein if there is not match in step hh) then the matching step c) further comprises:
ii) determining if there is a match between the unaltered first selected part of the first information parts with an information part stored in the information database, and if not,
jj) determining if there is a match between an altered version of the first selected part of the first information parts with a information part stored in the information database.

59. A method according to claim 48, wherein the advertising parties being represented in the message database has an account at the service provider system.

60. A method according to claim 59, wherein for at least part of or for all messages there is defined a maximum number of allowable selections within a given time period.

61. A method according to claim 50, wherein a selected message represents an associated message having the lowest ratio between number of times the message has been selected within the given time period and the maximum number of allowable selections within said given time period.

62. A method according to claim 61, wherein for a second part of the messages stored in the message database there are no defined criteria to be met and each of said messages may be associated with any information parts stored in the information database.

63. A method according to claim 48, wherein the information database can be updated with news relating to pieces of music, movies/videos, artists and/or music albums by third parties being communicating with the service provider system.

64. A method according to claim 63, wherein the information database comprises information parts representing pictures and/or album cover pictures.

65. A method according to claim 64, wherein a selected message comprises one or more advertisements and/or a link to a website of the related advertising party.

66. A method according to claim 48, wherein the service provider system stores one or more music numbers and/or movies/videos, which can be downloaded from the service provider system to a user terminal.

67. A method according to claim 66, wherein at least part of the music numbers and/or movies/videos are uploaded by third parties to the service provider system.

68. A method according to claim 66, wherein at least part of the music numbers and/or movies/videos stored at the service provider system are encrypted, and wherein a service provider media player for playing said encrypted music numbers and/or movies/videos can be downloaded from the service provider system to a user terminal.

69. A method according to claim 68, wherein said service provider media player is downloaded to a user terminal, and an encrypted music number or movie/video is downloaded from the service provider system and played by use of said service provider media player at the user terminal.

70. A method according to claim 66, wherein, when there has been a match in step c) and the played selected piece of music or movie/video has been identified and the second information has been forwarded to the user terminal step e), said method further comprises that the user provide instructions to the service provider system for forwarding the selected piece of music or movie/video and/or information to one more identified receivers.

71. A method according to claim 70, wherein when the selected piece of music or movie/video is not available for download from the service provider system, the service provider system forward information related to the selected piece of music or movie/video to the one or more identified receivers.

72. A method according to claim 70, wherein when the selected piece of music or movie/video is available as a free download from the service provider system, the service provider system forward download instructions for the selected piece of music or movie/video to the one or more identified receivers.

73. A method according to claim 70, wherein when the selected piece of music or movie/video is available as a download, but not as a free download, from the service provider system, the service provider system forward payment instructions for the selected piece of music or movie/video to the one or more identified receivers.

74. A method according to claim 48, wherein the service provider system further holds one or more databases for statistic information, and wherein at least part of the second information and information of the selected messages is stored in the one or more databases for statistic information.

75. A method according to claim 74, wherein the user clicks on an advertisement being forwarded to the user terminal as part of a forwarded selected message, and the clicking on the advertisement is registered at the service provider system and stored in the one or more databases for statistic information.

76. A computer system for distributing information relating to a piece of music and or a movie/video, said computer system comprising:
a service provider system holding an information database with information parts relating to pieces of music and/or movies/videos and/or artists and/or music albums and further holding a message database with messages relating to one or more advertising parties; and
a user terminal communicating with the service provider system;
wherein the user terminal is adapted for playing a selected piece of music and/or movie/video, extracting first information comprising several information parts relating to said selected piece of music and/or movie/video, and forwarding said first information from the service provider system; and
wherein the service provider system is adapted for
determining if there is a match between all of or part of the first information parts with corresponding information part or parts stored in the information database, and when there is a match, selecting second information stored in the information database and relating to at least part of the first information, said second information holding information parts not being part of the first information; said service provider system further being adapted for selecting one or more messages from the message database, and for forwarding said second information and the selected message(s) to the user terminal.

77. A computer system according to claim 76, wherein for all or a first part of the messages stored in the message database there is defined one or more criteria whereby each of said messages is associated with a selected number of the information parts stored in the information database.

78. A computer system according to claim 77, wherein the service provider system is adapted for selecting said one or more messages from messages being associated with the matching information part or parts stored in the information database.

79. A computer system according to claim 76, wherein for at least part of or for all messages there is defined a maximum number of allowable selections within a given time period.

80. A computer system according to claim 79, wherein the service provider system is adapted for selecting a message having the lowest ratio between number of times the message has been selected within the given time period and the maximum number of allowable selections within said given time period.

81. A computer system according to claim 77, wherein for a second part of the messages stored in the message database there are no defined criteria to be met and each of said messages may be associated with any information parts stored in the information database.

82. A computer system according to claim 76, wherein the service provider system is adapted for forwarding the first information and the selected message(s) to the user terminal, when there is no match between the first information parts and the information parts stored in the information database.

83. A computer system according to claims 76, wherein the user terminal is adapted for displaying the first and/or second information and the selected message(s) being received from the service provider system.

84. A computer system according to claims 76, wherein the service provider system is adapted for performing an identification of the played, selected piece of music and/or movie/video from information parts stored in the information database having a match with said first information part(s).

85. A computer system according to claim 76, wherein the service provider system is adapted for:
determining if there is a match between all of or part of the first information parts with information parts stored in the information database, and if not,
altering the information of one or more parts of the first information parts, and
determining if there is a match between the combination of any remaining unaltered first information parts and the altered part(s) with information parts stored in the information database.

86. A computer system according to claims 76, wherein the service provider system is adapted for:
aa) determining if there is a match between all of the first information parts with information parts stored in the information database, and if not,
altering the information of one or more parts of the first information parts, and
bb) determining if there is a match between the combination of any remaining unaltered first information parts and the altered part(s) with information parts stored in the information database.

87. A computer system according to claim 86, wherein, when there is no match in bb), then the service provider system is further adapted for:
cc) cancelling a first selected part of the unaltered first information parts,
dd) determining if there is a match between all the remaining unaltered first information parts with information parts stored in the information database, and if not,
altering the information of one or more parts of the remaining unaltered first information parts, and
ee) determining if there is a match between the combination of any remaining unaltered first information part(s) and the altered part(s) with information parts stored in the information database.

88. A computer system according to claim 87, wherein, when there is no match in ee), then the service provider system is further adapted for:
ff) cancelling a second selected part of the unaltered first information parts,
gg) determining if there is a match between all the remaining unaltered first information parts with information parts stored in the information database, and if not,
altering the information of one or more parts of the remaining unaltered first information parts, and
hh) determining if there is a match between the combination of any remaining unaltered first information part(s) and the altered part(s) with information parts stored in the information database.

89. A computer system according to claim 88, wherein, when there is not match in hh) then the service provider system if further adapted for:
ii) determining if there is a match between the unaltered first selected part of the first information parts with a information part stored in the information database, and if not,
jj) determining if there is a match between an altered version of the first selected part of the first information parts with an information part stored in the information database.

90. A computer system according to claim 76, wherein the information database comprises information parts representing pictures and/or album cover pictures.

91. A computer system according to claim 76, wherein a selected message comprises one or more advertisements and/or a link to a website of the related advertising party.

92. A computer system according to claim 76, wherein the service provider system stores one or more music numbers and/or movies/videos, which can be downloaded from the service provider system to a user terminal.

93. A computer system according to claim 92, wherein at least part of the music numbers and/or movies/videos stored at the service provider system are encrypted, and wherein a service provider media player for playing said encrypted music numbers and/or movies/videos can be downloaded from the service provider system to a user terminal.

94. A computer system according to claim 76, wherein the service provider system further holds one or more databases for statistic information, and wherein at least part of the second information and information of the selected messages is stored in the one or more databases for statistic information.
